(19) United States
(12) Patent Application Publication
(10) Pub. No.: US 2003/0147564 A1
(43) Pub. Date: Aug. 7, 2003

(54) Fast hybrid interpolation methods

(76) Inventor: Chulhee Lee, Goyang-City (KR)

Correspondence Address: Chulhee Lee, Dongbu-Apt 509-204, Jooyeob-Dong 47, Ilsan-Gu, Goyang-city, Gyounggi-Do, 411-744, KR

(21) Appl. No.: 10/060,777

(22) Filed: Feb. 1, 2002

(51) Int. Cl. G06K 9/32

(52) U.S. Cl. 382/300

(57) ABSTRACT

Hybrid interpolation methods are provided that employ more than one interpolation algorithm and choose the most appropriate interpolation algorithm that provides high quality images with a minimum processing time. Prediction means is first applied to predict which interpolation is most appropriate for a given pixel in terms of complexity and performance. Then, a simple interpolation algorithm is used for pixels for which the simple interpolation algorithm provides acceptable performances and a complex interpolation algorithm is used for pixels for which the complex interpolation algorithm, which requires a larger number of operations, significantly outperforms the simple interpolation algorithm. Consequently, it is possible to obtain high quality images without significantly increasing the processing time.

### BACKGROUND OF THE INVENTION

1. Field of the Invention

This invention relates to fast hybrid interpolation methods that provide high quality images. The hybrid interpolation methods employ more than one interpolation algorithm and choose the most appropriate algorithm that provides high quality images with a minimum processing time.

2. Description of the Related Art

Interpolation is a basic operation in image processing and is routinely used in image enlargement and reduction. For instance, interpolation is used in image and video resizing. It is also required in single chip CCDs that are widely used in digital cameras and camcorders. Furthermore, interpolation is used in sub-pixel motion estimation in video compression and is also required in de-interlacing.

Numerous interpolation algorithms have been proposed, and there are significant differences in complexity and performance. Usually, a simple and fast interpolation algorithm requires a small number of operations but provides a relatively limited performance. On the other hand, a complex algorithm requires a large number of operations but provides a much better performance. For instance, the nearest neighbor interpolation algorithm is the simplest and fastest. However, the resulting image is somewhat blocky. Although the bilinear interpolation algorithm is fast and provides relatively good performance, it tends to blur edges. High degree spline interpolation methods provide much better results, but the processing time increases significantly due to the large increase in operations. In addition, there are many other interpolation algorithms that do not use polynomials. For example, interpolation algorithms using neural networks have also been proposed. Although they provide relatively good performances, they require a large number of operations due to the nature of neural networks.

In general, there is a large variation in numbers of operations among various interpolation algorithms. Typically, interpolation for two-dimensional images is performed as a series of one-dimensional interpolations. In other words, rows are processed first, and then columns are processed, or vice versa. When interpolation is performed separately in each direction, the value of a new pixel is obtained from its two neighbor pixels in the linear interpolation, requiring 2 additions and one multiplication. In the cubic spline interpolation, the value of a new pixel is computed from its four neighbor pixels, requiring 3 additions and 4 multiplications. Thus the processing time increases roughly by a factor of 4 when the number of multiplications is considered. If the B-spline of degree 5 is used for interpolation, the value of a new pixel is computed from its 6 neighbor pixels, requiring 5 additions and 6 multiplications. Although one can obtain a better quality image if a high degree B-spline interpolation algorithm is used, the high degree B-spline interpolation requires a significantly longer processing time. In other words, one obtains a better quality image if a complex interpolation algorithm is used. However, such a complex algorithm requires a large number of operations, thus significantly increasing the processing time.

In many applications, the processing time is critical. For instance, the single chip color filter array CCD, which is widely used in digital cameras and camcorders, needs interpolation operations to fill missing colors in the color filter array (FIG. 19). If the processing time is too long, this can cause a serious problem. For a digital camera, it will take a long time to take a picture and store it. For a camcorder, a fast processor may be required since it should handle at least 30 images per second in order to produce acceptable video signals. Furthermore, when interpolation is used for video resizing or de-interlacing, the processing time is also critical. Otherwise, the processor may not display the video properly. If interpolation is used for sub-pixel motion estimation in video compression, the processing time is very critical. Thus, if one can devise an interpolation algorithm that is fast while providing high quality images, such an algorithm would have many useful applications.

In general, a complex interpolation algorithm that requires more computations provides a better performance than a simple interpolation algorithm that requires fewer computations. However, in many cases, the differences are negligible in most pixels. Major differences occur around edges where high frequency components are dominant. Thus, if one can predict whether the difference will be small or large, one can use a simple interpolation algorithm for regions where differences are small and employ a complex interpolation algorithm for regions where differences are large. In other words, prediction means is first applied to determine which interpolation algorithm is the most appropriate algorithm that provides high quality images with a minimum processing time. Then, one can obtain high quality images without significantly increasing the processing time since in most images the difference between the simple interpolation algorithm and the complex interpolation algorithm would be minor except in some small regions.

It is noted that the prediction means, which predicts whether the difference will be small or large, should be simple and fast. Otherwise, the saving in processing time may not be so large. Thus, according to the teaching of the present invention, prediction means is first applied. Then, a simple but fast interpolation algorithm is used for pixels where the simple interpolation algorithms provide acceptable performances and a complex interpolation algorithm is used for pixels where the complex interpolation algorithm, which requires a larger number of operations, significantly outperforms the simple interpolation algorithm

### SUMMARY OF THE INVENTION

There is a great need for a fast interpolation algorithm that provides high quality images. Generally, a complex interpolation method requiring more computations provides a better performance than a simple interpolation method that needs fewer computations. By noting that the differences between the simple and the complex interpolation algorithms are minor in most regions with major differences occurring around edges where high frequency components are dominant, the present invention provides hybrid interpolation methods which employ more than one interpolation algorithm and choose the most appropriate interpolation algorithm that provides high quality images with a minimum processing time.

Thus, it is an object of the present invention to provide a hybrid interpolation method that is fast while maintaining high quality images.

### BRIEF DESCRIPTION OF THE DRAWINGS

FIG. 1a shows the B-spline of degree 0.

FIG. 1b shows the B-spline of degree 1.

FIG. 1c shows the B-spline of degree 3.

FIG. 2a illustrates how a new pixel value is computed using the linear interpolation (B-spline of degree 1).

FIG. 2b illustrates how the linear interpolation (B-spline of degree 1) works for 1-dimensional data.

FIG. 3a shows a one-dimensional data.

FIG. 3b shows the coefficients of the B-spline of degree 3 of the data of FIG. 3a.

FIG. 3c illustrates how the continuous model is obtained from the coefficients of the B-spline of degree 3.

FIG. 3d illustrates how the cubic spline interpolation (B-spline of degree 3) works.

FIG. 4 shows an original image.

FIG. 5 shows an image enlarged by a factor of \sqrt{2} using the bilinear interpolation algorithm.

FIG. 6 shows an image enlarged by a factor of \sqrt{2} using the cubic spline interpolation algorithm.

FIG. 7 shows the difference image between the two images enlarged by the bilinear and cubic spline interpolation algorithms.

FIG. 8 shows the histogram of the difference image.

FIG. 9 shows the table of the differences between the bilinear and the cubic spline interpolation methods along with proportions and accumulations.

FIG. 10 shows the flowchart of a hybrid interpolation method that employs two interpolation algorithms.

FIG. 11a shows the flowchart of a hybrid interpolation method that chooses one of two interpolation algorithms, depending on the difference between the two nearest neighbor pixels.

FIG. 11b shows how the difference between the two nearest neighbor pixels is computed.

FIG. 12a shows an interpolation example.

FIG. 12b illustrates how the hybrid interpolation method of FIG. 11 works.

FIG. 13 shows the flowchart of a hybrid interpolation method that employs more than two interpolation algorithms.

FIG. 14 shows the flowchart of another hybrid interpolation method that employs more than two interpolation algorithms.

FIG. 15a shows an interpolation example.

FIG. 15b shows a case in which the bilinear interpolation algorithm provides a good performance.

FIG. 16 shows the flowchart of a hybrid interpolation algorithm that chooses one of the interpolation algorithms depending on the slopes of the adjacent pixels.

FIG. 17 shows a more efficient implementation of the hybrid interpolation of FIG. 16.

FIG. 18a shows an interpolation example.

FIG. 18b shows a case in which the bilinear interpolation algorithm provides a noticeably different interpolation result from that of the cubic spline interpolation algorithm.

FIG. 19 shows an example of the Bayer color filter array.

FIG. 20 shows the green color pattern in the Bayer color filter array.

FIG. 21 shows the red color pattern in the Bayer color filter array.

FIG. 22a shows the flowchart of a hybrid interpolation that chooses one of the interpolation algorithms depending on the differences between four adjacent pixels.

FIG. 22b shows how the differences between four adjacent pixels are computed.

FIG. 23 shows a more efficient implementation of the hybrid interpolation of FIG. 22 when interpolation is used for a color filter array.

FIG. 24a shows the 4 nearest neighbor pixels of a new pixel to be interpolated.

FIG. 24b shows the 16 nearest neighbor pixels of a new pixel to be interpolated.

FIG. 25 shows a more efficient implementation of the hybrid interpolation of FIG. 17.

### REFERENCES

[1] Michael Unser, “Splines A perfect Fit for Signal and Image Processing,” IEEE Signal Processing Magazine, November 1999.

### DESCRIPTION OF THE ILLUSTRATED EMBODIMENTS

### Embodiment 1

The standard procedure for interpolation is to fit the digital data with a continuous model and then resample the function at a desired sampling rate. Quite often, splines, which are piecewise polynomials, are used in interpolation. In particular, B-splines are favored in image interpolations.

In the B-spline interpolation model [1], the signal is modeled as follows:

$$s ( x ) = {\sum }_{j ∈ Z} c ( j ) {β}^{n} ( x - j )$$

where βⁿ(x) is the B-spline of degree n, and c(j) is the B-spline coefficient. In particular, β¹(x) and β³(x) are given by

$$\begin{matrix}{β}^{1} ( x ) = \{ \begin{matrix}1 - \vert x \vert & 0 \leq \vert x \vert < 1 \\ 0 & 1 \leq \vert x \vert \end{matrix} & ( 1 ) \\ {β}^{3} ( x ) = \{ \begin{matrix}2 / 3 - {\vert x \vert}^{2} + {\vert x \vert}^{3} / 2 & 0 \leq \vert x \vert < 1 \\ {( 2 - \vert x \vert )}^{3} / 6 & 1 \leq \vert x \vert < 2. \\ 0 & 2 \leq \vert x \vert \end{matrix} & ( 2 )\end{matrix}$$

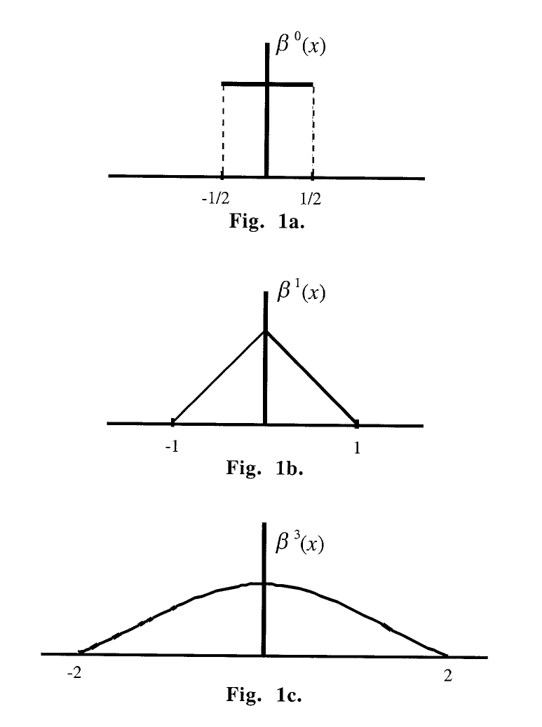

FIG. 1a shows the B-spline of degree 0, β⁰(x). FIG. 1b shows the B-spline of degree 1, β¹(x). FIG. 1c shows the B-spline of degree 3, β³(x). For splines of degree 0 (the nearest neighbor interpolation) and splines of degree 1 (the bilinear interpolation), the B-spline coefficients, c(k), are the same as the signal samples, s(k). In other words,

c(k)=s(k).

For high-degree B-splines, the coefficients can be computed using a digital filter as follows [1]:

c(k)=(b₁ⁿ)⁻¹s(k) (3)

where b₁ⁿ(k)=βⁿ(x)|ₓ₌ₖ. For the cubic spline interpolation, the coefficients can be computed using the following filter:

$${( {b}_{1}^{3} )}^{- 1} ( k ) {↔}^{z} \frac{6}{z + 4 + {z}^{- 1}} . \qquad ( 4 )$$

where

$${↔}^{z}$$

represents the z-transform.

Typically, interpolation for two-dimensional images is performed as a series of one-dimensional interpolations. In other words, rows are processed first, and then columns are processed, or vice versa. Similarly, three-dimensional interpolation can be performed as a series of one-dimensional interpolations. When interpolation is performed separately in each direction, the linear interpolation computes the value of a new pixel from its two neighbor pixels. The cubic spline interpolation computes the value of a new pixel from its four neighbor pixels.

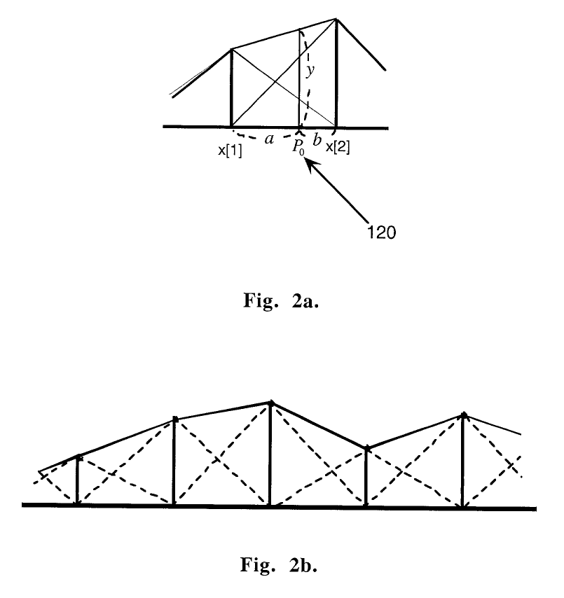

Thus, for the bilinear interpolation (FIG. 2a), the value of a new pixel at P₀ 120 will be calculated as follows:

y=ax[2]+bx[1]=ax[2]+(1−a)x[1]=x[1]+a(x[2]−x[1]) (5)

where x[1] and x[2] are signal samples. As can be seen in the above equation, two additions and one multiplication are required to compute the value of the new pixel using the bilinear interpolation algorithm. FIG. 2b shows the result when the bilinear interpolation method is applied to 1-dimensional data.

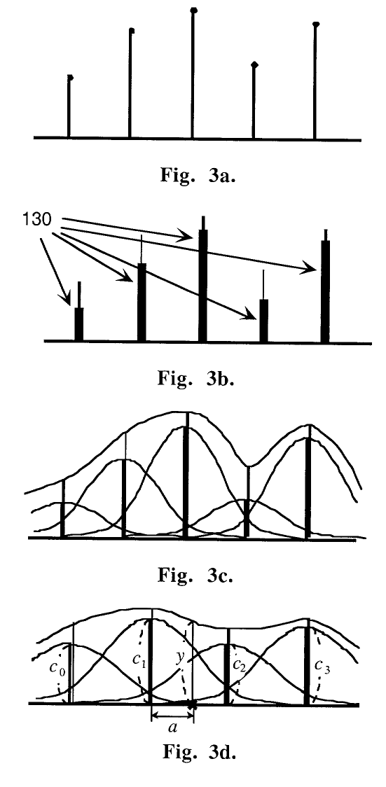

As stated previously, for the cubic spline interpolation, the B-spline coefficients first need to be computed. In order to compute the B-spline coefficients, two additions and two multiplications are needed for each pixel as can be seen from Equation (4). FIG. 3 illustrates the procedure of the cubic spline interpolation method. From the digital data (FIG. 3a), the B-spline coefficients 130 (bold line) are computed (FIG. 3b). The interpolation result is shown in FIG. 3c. Then, the value of a new pixel will be calculated from the coefficients of its four neighbor pixels using Equation (2). For instance, the value of a new pixel is computed as follows:

y=c₀β³(1+a)+c₁β³(a)+c₂β³(1−a)+c₃β³(2−a), (6)

as illustrated in FIG. 3d. Thus, 3 additions and 4 multiplications are required to compute the value of the new pixel using the cubic spline interpolation algorithms, assuming that β³(1+a), β³(a), β³(2−a) and β³(1−a) are already computed and saved. Since multiplication is one of the most time-consuming operations in hardware implementation, it can be said that the processing time of the cubic spline interpolation is about 4 times that of the bilinear interpolation without counting the computation time for the B-spline coefficient. It is noted that there are many other methods for implementing the high degree spline interpolation methods that include cubic spline interpolation methods. It is further noted that the present invention is not restricted to any special implementation of the spline interpolation methods.

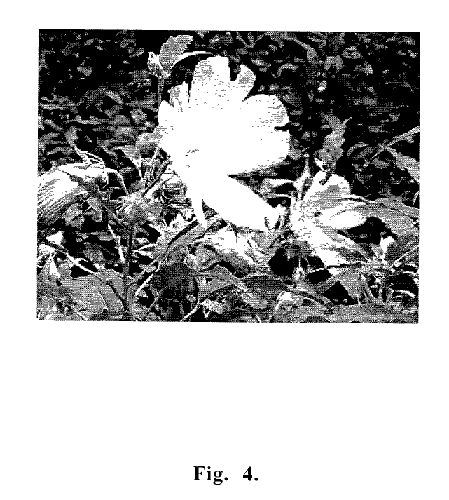

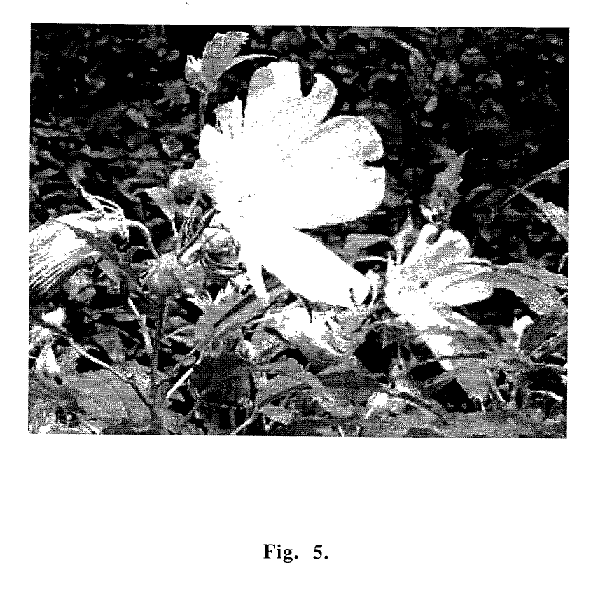

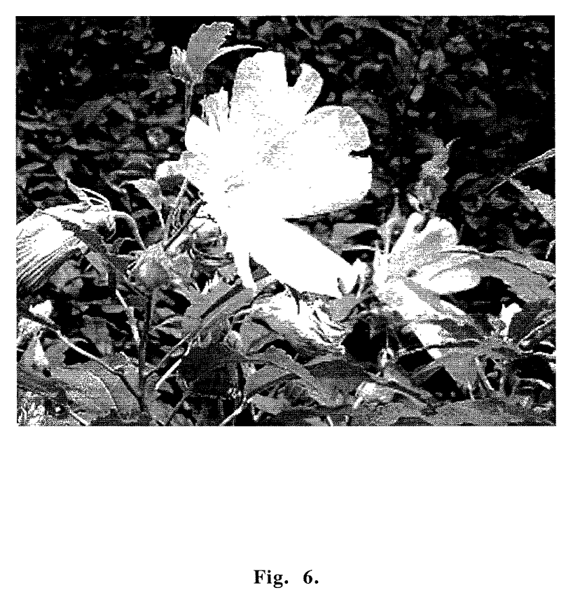

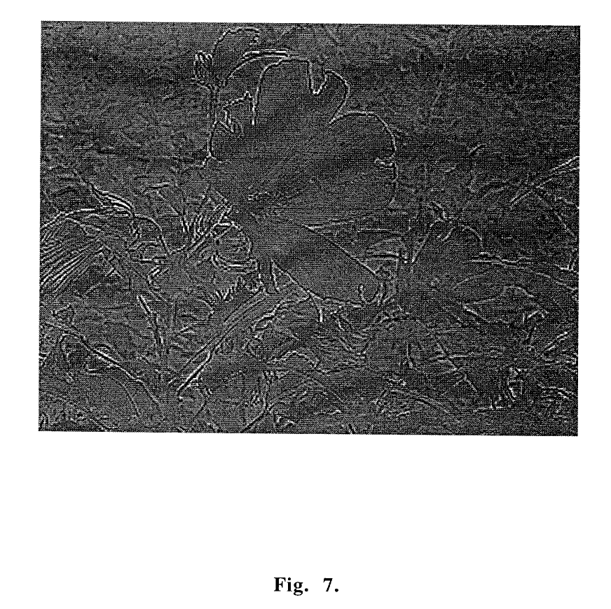

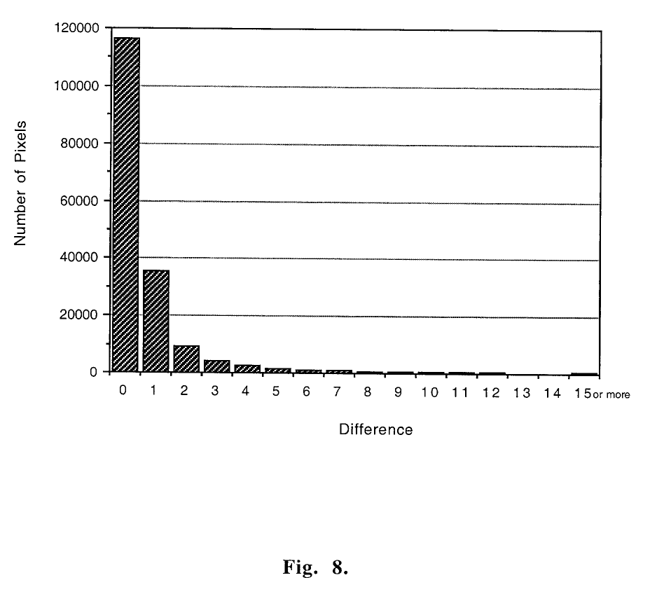

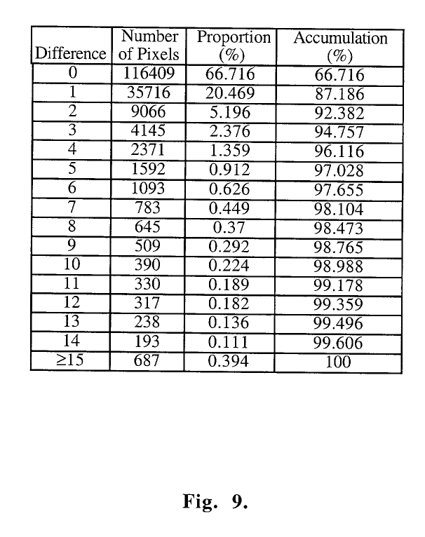

Next, it will be illustrated how two interpolation algorithms can be used to produce a high quality image without significantly increasing the processing time. FIG. 4 shows an original image. FIG. 5 shows the image enlarged by a factor of \sqrt{2} using the bilinear interpolation algorithm and FIG. 6 shows the image enlarged by the same factor using the cubic spline interpolation algorithm. FIG. 7 shows the difference image between the two images enlarged by the two interpolation algorithms. As can be seen in FIG. 7, most pixels of the difference image are very small in value, indicating that the performances of the two interpolation algorithms are almost identical except in some small regions, particularly around edges. FIG. 8 shows the histogram of the difference image of FIG. 7. FIG. 9 shows the table of the differences between the bilinear interpolation and the cubic spline interpolation algorithms along with proportions and accumulations. As can be seen in the table, for about 67% of the whole pixels, there is no difference between the bilinear interpolation and the cubic spline interpolation algorithms. Furthermore, for more than 96% of pixels, the differences are smaller than 5. Typically, when the difference is small enough, the human eye cannot distinguish between them. Only about 4% of the pixels have differences larger than 5. The large differences occur along edges where pixel values change abruptly.

As stated previously, the processing time of the cubic spline interpolation algorithm is roughly 4 times that of the bilinear interpolation. Thus, if it is possible to devise means to predict whether the difference between the bilinear interpolation and the cubic spline interpolation algorithms will be small or large, one can use the bilinear interpolation for pixels where the two interpolation algorithms provide similar performances and the cubic spline interpolation algorithm for pixels where the cubic spline interpolation algorithm significantly outperforms the bilinear interpolation algorithm. Then, high quality images can be obtained without increasing the processing time significantly. For example, if the differences between the bilinear and cubic spline interpolation algorithms are larger than a threshold for only 5% of the total pixels, one can use the bilinear interpolation algorithm for 95% of the total pixels and the cubic spline interpolation algorithm for the remaining 5%. In this case, the processing time increases by about 15% compared to the bilinear interpolation algorithm, assuming that the processing time is proportional to the number of multiplications. If the cubic spline interpolation is used for the whole image, the processing time will increase by roughly 300%. Thus, one can obtain image qualities that are comparable to those of the cubic spline interpolation algorithm, while the processing time is comparable to that of the bilinear interpolation. Although the bilinear interpolation and the cubic spline interpolation algorithms are used in the above example, it is noted that any two interpolation algorithms that differ in performance and complexity can be combined.

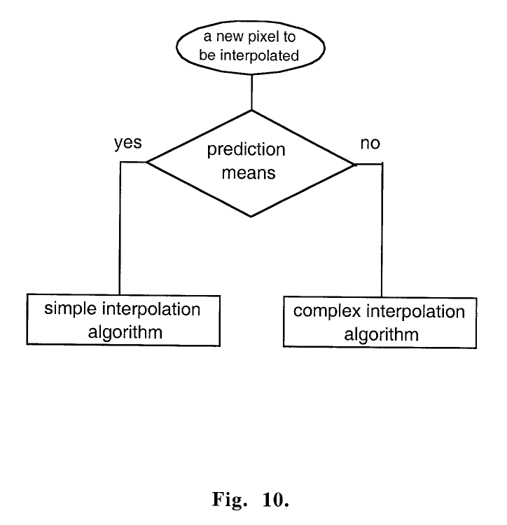

It is noted that the prediction means, which predicts whether the difference between the bilinear interpolation and the cubic spline interpolation algorithms will be small or large, should be simple and fast. If the prediction means is complex and requires a large number of operations, the saving in processing time may not be as large as one may wish. Thus, according to the teaching of the present invention, prediction means is first applied. Then, a simple but fast interpolation algorithm is used for pixels where it provides acceptable performance, and a complex interpolation algorithm is used for pixels where the complex interpolation algorithm, which requires a larger number of operations, significantly outperforms the simple interpolation algorithm. FIG. 10 illustrates the hybrid interpolation algorithm.

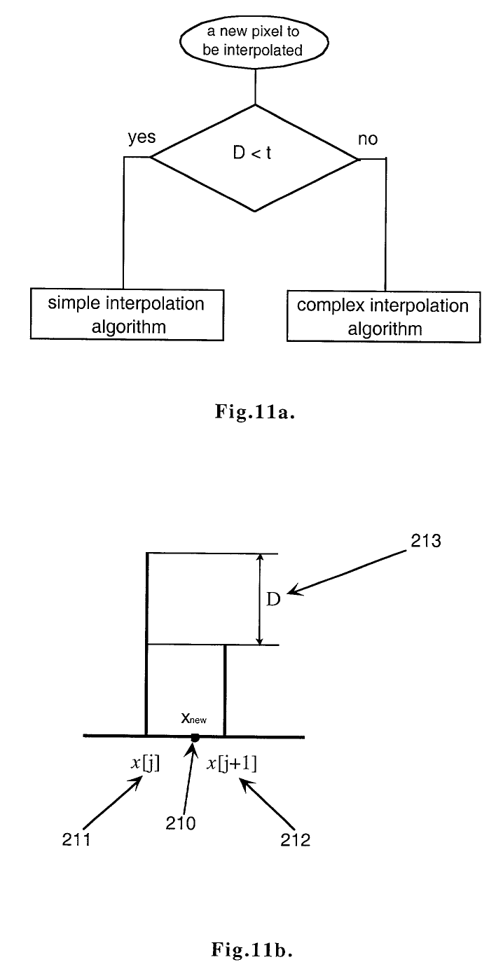

When interpolation is performed as a series of one-dimensional operations, a possible test is to check the two pixels that are nearest to the pixel to be interpolated. If they are similar in value, one can use a simple interpolation method that requires a small number of operations. If the difference between the two pixels is larger than a threshold t, one can use a complex interpolation method that usually requires a large number of operations. In other words, by examining the two pixels that are nearest to the pixel to be interpolated, one can determine what kind of interpolation method should be used. The flowchart of this procedure is shown in FIG. 11a. In order to find a new pixel value at x_{new} 210 (FIG. 11b), the two nearest neighbor pixels x[j] 211 and x[j+1] 212 are examined. If the difference 213 between the two pixels is smaller than a threshold t, a simple interpolation is used. Otherwise, a complex interpolation algorithm is used.

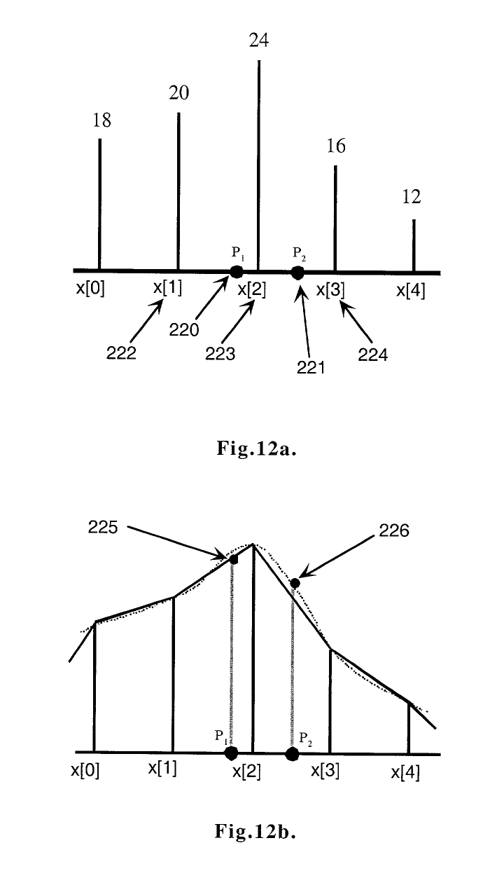

FIG. 12 illustrates how the procedure of FIG. 11 works when the bilinear interpolation algorithm and the cubic spline interpolation algorithm are used. In order to find a new pixel value at P₁ 220, the two nearest neighbor pixels x[1] 222 and x[2] 223, are examined. Since the difference is smaller than a threshold which is assumed to be 5, the bilinear interpolation algorithm is used, producing a value 225. Next, in order to find a new pixel value at P₂ 221, the two nearest neighbor pixels x[2] 223 and x[3] 224 are examined. Since the difference is larger than the threshold, the cubic interpolation algorithm is used, producing a value 226. The detailed implementation of the cubic spline interpolation algorithm can be found in [1]. In the above example, the bilinear interpolation and the cubic spline interpolation methods are used. However, one can combine any two B-spline functions with different degrees. For instance, one may use the bilinear interpolations and the B-spline of degree 7. In fact, one can combine any interpolation methods that differ in performance and processing time to produce an image quality that is comparable to that of the complex interpolation algorithm with a processing time that is comparable to that of the simple interpolation algorithm.

Numerous interpolation algorithms have been proposed by many researchers. Each interpolation algorithm has advantages and disadvantages. The idea and teaching of the present invention can be further extended to hybrid interpolations that employ more than two interpolation algorithms. With the proper prediction means, one can choose the most appropriate algorithm that provides high quality images with a minimum processing time.

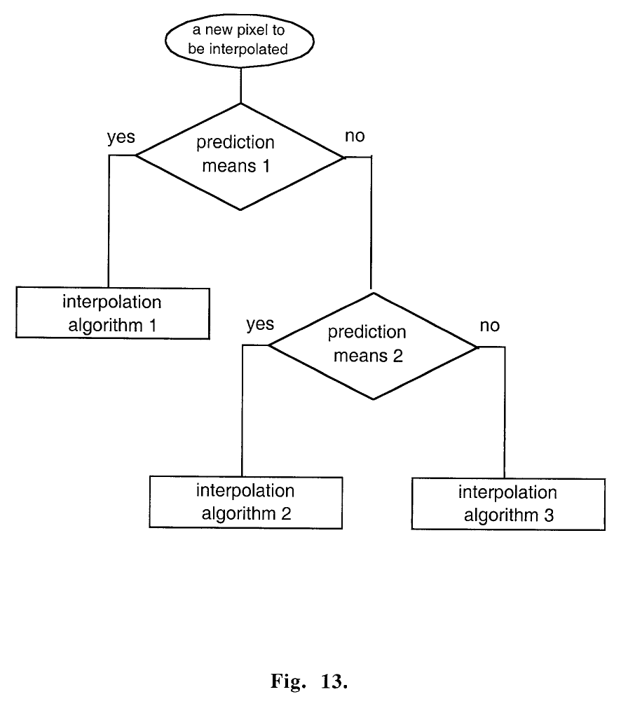

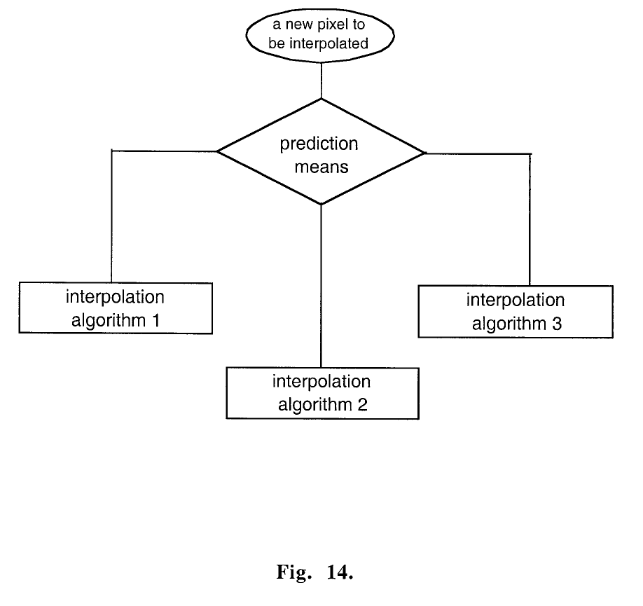

It is noted that there are many other tests which can be used to choose the most appropriate interpolation algorithm that provides high quality images with a minimum processing time. It is also noted that instead of a single prediction means, a series of prediction means can be used to choose the most appropriate interpolation algorithm, particularly when more than two interpolation algorithms are employed. For instance, in FIG. 13 a first prediction means is applied to each pixel to be interpolated. If a condition is met, Interpolation Algorithm 1 is used. Otherwise, a second prediction means is applied. According to the outcome of the second prediction means, either Interpolation Algorithm 2 or Interpolation Algorithm 3 is used. FIG. 14 shows another prediction means when three interpolation algorithms are used. Depending on the outcome of the prediction means, one of the three interpolation algorithms is selected.

### Embodiment 2

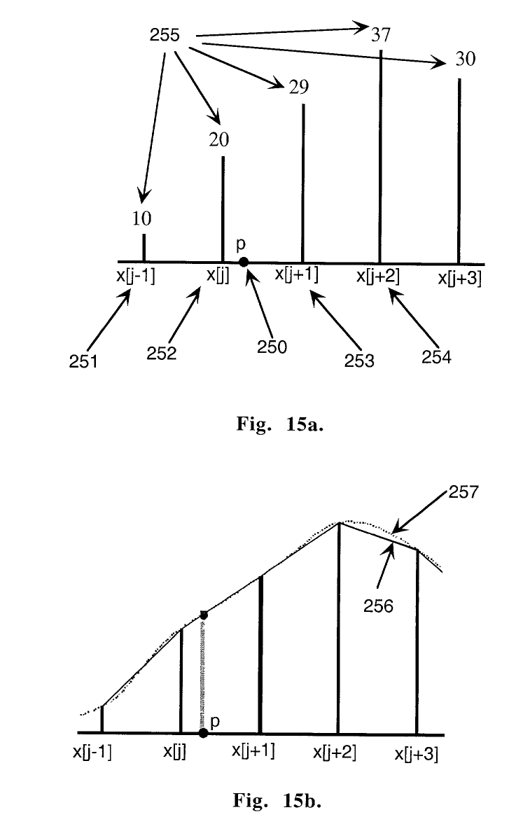

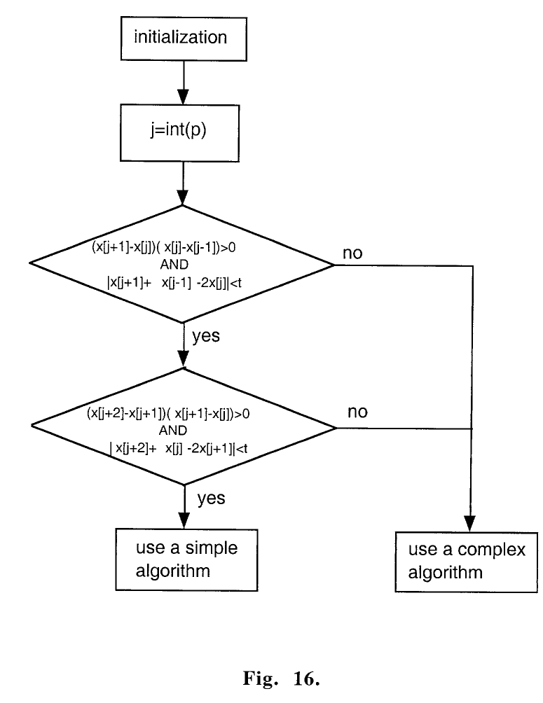

One of the primary regions where the difference between a simple interpolation method and a complex interpolation method is large is a region where changes of pixel values are irregular. Consider the example of FIG. 15a, where the numbers 255 represent the pixel value. In FIG. 15a, the slopes between adjacent pixels from x[j−1] 251 to x[j+2] 254 are relatively uniform. In this case, the bilinear interpolation method will provide relatively good performance for a new pixel at p 250, although the difference between the two nearest neighbor pixels, x[j] 252 and x[j+1] 253, is large, as can be seen in FIG. 15b where the solid line 256 represents the bilinear interpolation and the dotted line 257 the cubic spline interpolation. As can be seen, the interpolation values at p are almost identical. Therefore, another possible prediction means is to check the slopes of the adjacent pixels. If the slopes are similar, a simple linear interpolation algorithm is used. If the slopes vary significantly, a complex interpolation algorithm, such as the cubic spline interpolation algorithm, is used. FIG. 16 shows the flowchart of this prediction means. In FIG. 16, a new pixel at p is to be interpolated. First, the largest integer, j, that does not exceed p is computed by the following operation:

j=int(p).

Then, the difference between x[j+1] and x[j] and the difference between x[j] and x[j−1] are compared. If the following conditions are not satisfied:

(x[j+1]−x[j])(x[j]−x[j−1])>0 AND

|x[j+1]+x[j−1]−2x[j]|<t

where t is a threshold, a complex interpolation algorithm is used. Otherwise, the difference between x[j+2] and x[j+1] and the difference between x[j+1] and x[j] are compared. If the following conditions are satisfied:

(x[j+2]−x[j+1])(x[j+1]−x[j])>0 AND

|x[j+2]+x[j]−2x[j+1]|<t,

then a simple interpolation algorithm is used. Otherwise, a complex interpolation algorithm is used.

The location of the next pixel to be interpolated is determined as follows:

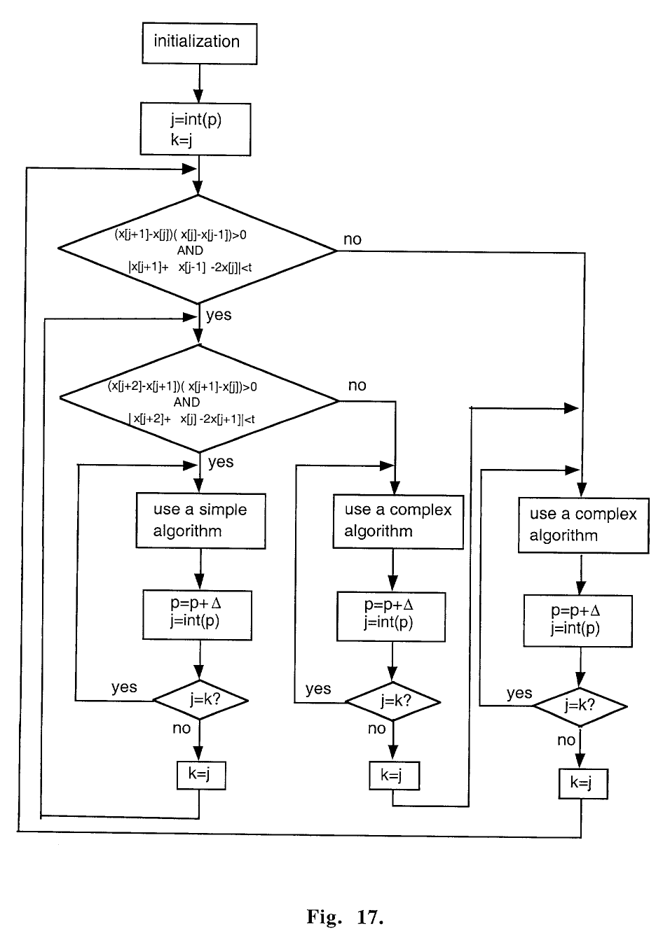

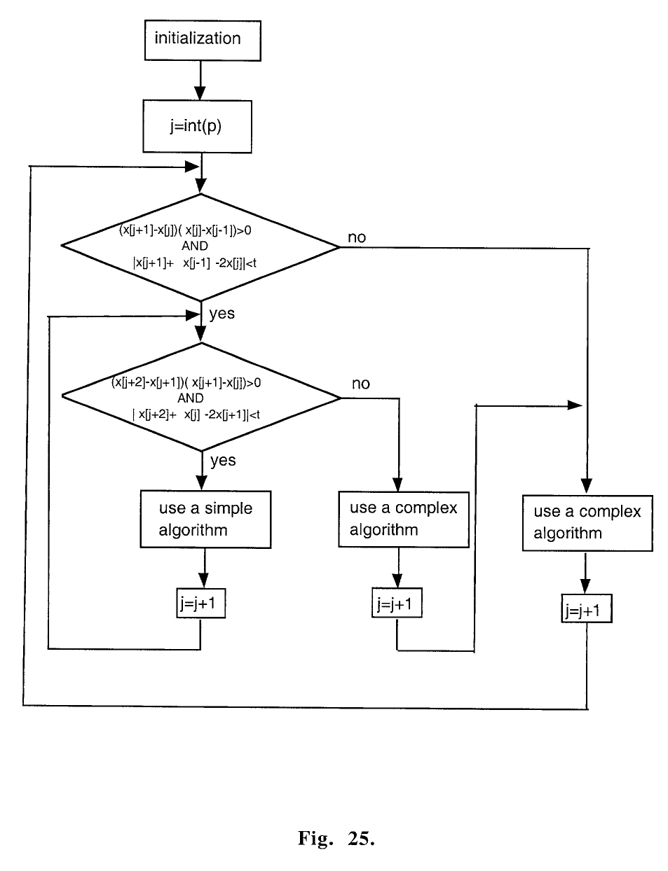

p=p+Δ,

where Δ is the inverse of the scale factor. In other words, if the image is enlarged by 2, Δ is 0.5. If the image is to be enlarged, Δ will be always smaller than 1. In this case, one can use the prediction mechanism of FIG. 17, which reduces the number of comparisons. In particular, the image is to be enlarged by a factor of 2, the prediction means in FIG. 25 can be used, which is more efficient.

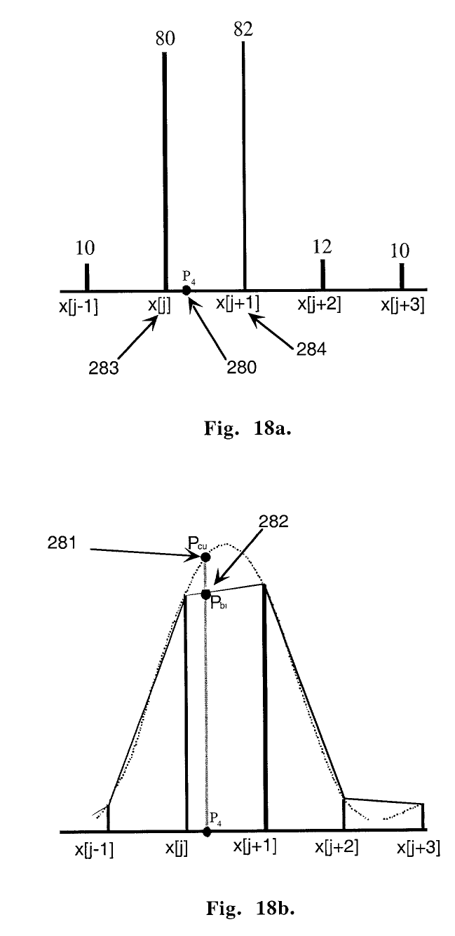

FIG. 18a shows an example in which the variance of slopes in the vicinity of a new pixel P₄ 280 is large. In this case, a complex interpolation algorithm, such as the cubic spline interpolation, might provide a better performance than a simple interpolation such as the bilinear interpolation. For instance, the pixel value P_{cu} 281 that the cubic spline interpolation provides appears to provide a more accurate interpolation result than the pixel value P_{bi} 282 that the bilinear interpolation algorithm provides (FIG. 18b).

### Embodiment 3

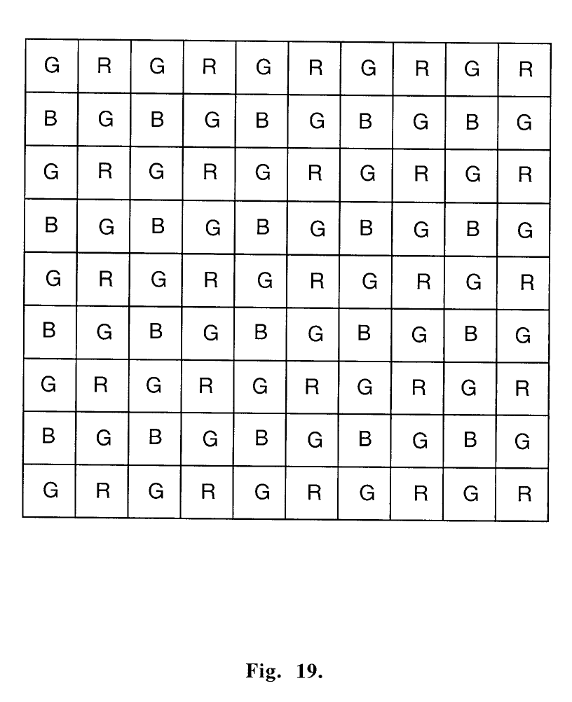

In order to reduce cost and size, the single chip CCD is widely used instead of 3 CCD sensors in consumer electronics such as digital cameras and camcorders. In the single chip CCD, color images are obtained by a color filter array (CFA). FIG. 19 shows an example of the Bayer color filter array. In FIG. 19, G stands for green, R for red and B for blue. In order to obtain a full color image, the missing colors should be interpolated. In practice, it is important to obtain a good quality image using an interpolation algorithm that does not require too many operations for single chip CCD sensors in consumer electronics. Otherwise, it would increase cost and size. Furthermore, interpolation methods that require a large number of operations tend to consume a large amount of power, which is a limited resource in portable electronics such as camcorders or digital still cameras. The idea and teaching of the present invention can also be applied to this case. In other words, in order to interpolate a missing color, the prediction means is first applied to determine which interpolation algorithm is most appropriate. Then, a simple but fast interpolation algorithm is used for the missing color where the simple interpolation algorithms provide acceptable performances and a complex interpolation algorithm is used for the missing color where the complex interpolation algorithm, which requires a larger number of operations, significantly outperforms the simple interpolation algorithm.

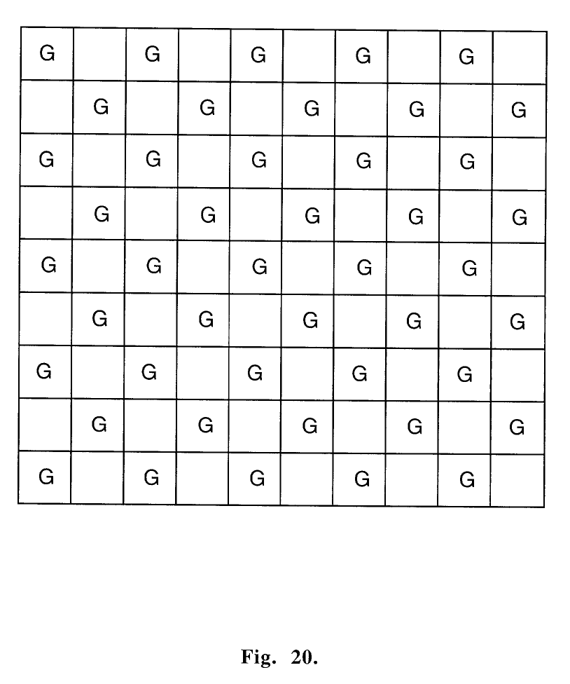

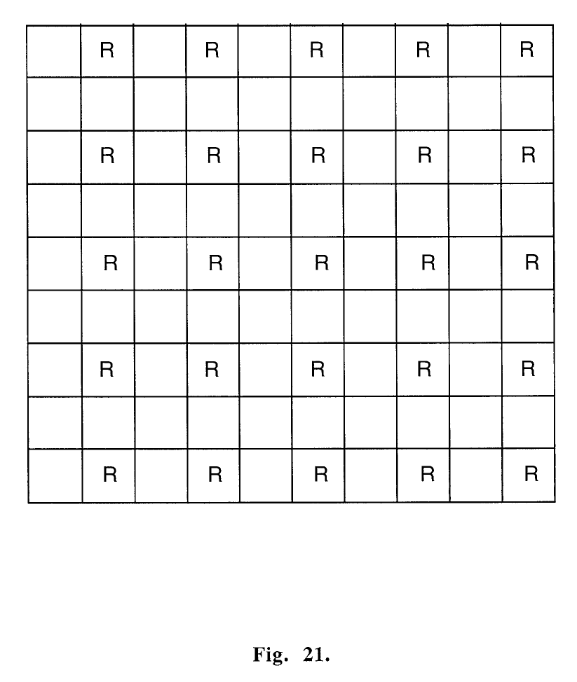

There are many possible ways to fill in those missing colors. For example, in order to fill a missing green color in FIG. 20, one may interpolate the missing value from its vertical neighbor pixels. Alternatively, one may interpolate the missing value from its horizontal neighbor pixels. Another possible way is to take the average of the interpolated values that are obtained from the horizontal and vertical neighbor pixels. In order to fill in a missing red color in FIG. 21, one may first fill some of missing pixels from horizontal neighbor pixels and then fill some of missing pixels from vertical neighbor pixels. The remaining missing pixels can be filled in the same way as the green color. It is noted that there are many other possibilities to fill in the missing colors. The teaching of the present invention is not concerned with the order in which the interpolation is performed.

### Embodiment 5

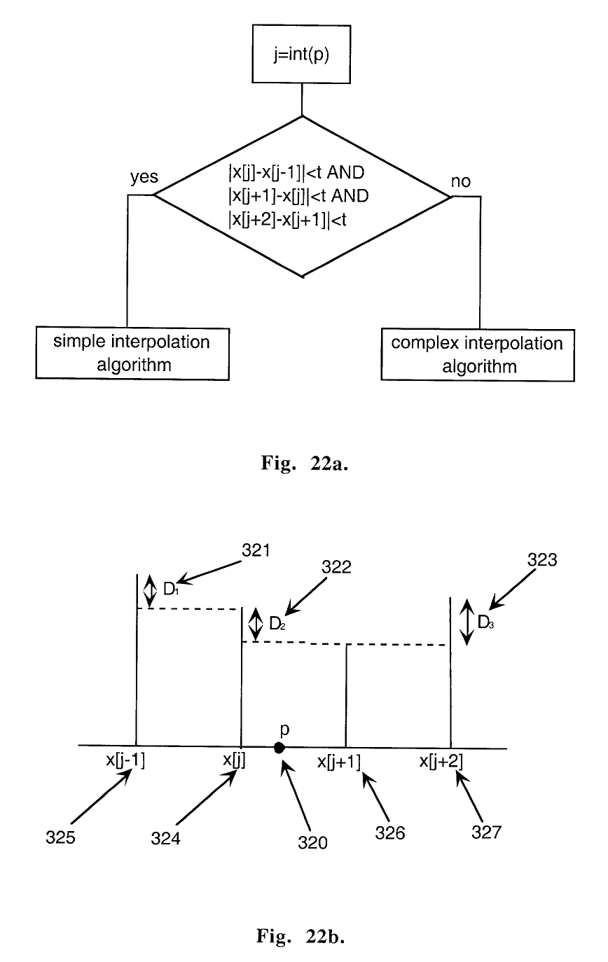

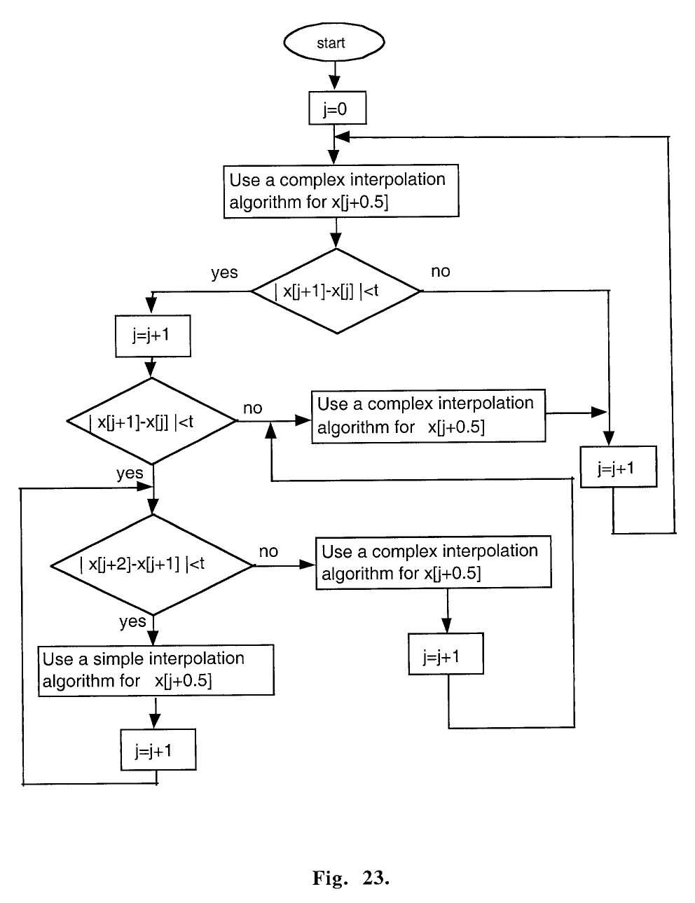

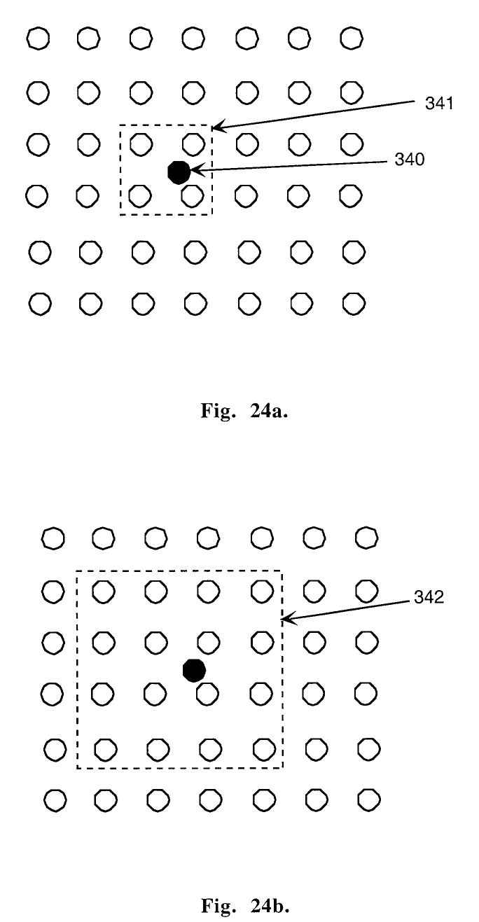

The example of FIG. 15 shows that if the rates of change in the adjacent pixels are relatively uniform, the simple bilinear interpolation method provides a good performance even though the difference of the two nearest pixels (x[j] 252, x[j+1] 253) is large. On the other hand, FIG. 18 illustrates a different case. If the rates of change in the adjacent pixels have a large variance, the bilinear interpolation algorithm provides a very different interpolation result from that of the cubic spline interpolation algorithm, even though the difference between the two nearest pixels (x[j] 283, x[j+1] 284) is small. FIG. 22a shows another possible prediction means that takes this phenomenon into account. In order to interpolate a new pixel value at p 320 (FIG. 22b), the four nearest neighbor pixels (x[j−1] 325, x[j] 324, x[j+1] 326, x[j+2] 327) are examined with index j which is the largest integer that does not exceed p. Then, a simple interpolation algorithm is used only if all three differences (D₁ 321, D₂ 322, D₃ 323) of the four neighbor pixels (x[j−1] 325, x[j] 324, x[j+1] 326, x[j+2] 327) are smaller than a threshold (FIG. 18b). In the case of the single chip color filter array where the color patterns are very regular, the prediction scheme in FIG. 23, which is more efficient, can be used. An advantage of the prediction means in FIG. 23 over that of FIG. 22a is that the prediction means in FIG. 23 needs a smaller number of comparisons. It is noted that the method in FIG. 23 can also be used if the image is to be enlarged by a factor of 2.

### Embodiment 6

When the bilinear interpolation method and the cubic spline interpolation method are employed, the B-spline coefficients first need to be computed. As stated previously, in order to compute the coefficients of the B-spline of degree 3, 2 multiplications and 2 additions are required for each pixel. Although the cubic spline interpolation is used only for a small portion of the image, the B-spline coefficients are computed for the whole image. Thus, according to the teaching of the present invention, the cardinal spline of degree 3 is used instead of the B-spline of degree 3. An advantage of the use of the cardinal spline is that one does not have to compute the coefficients, since they are the same as the signal values. However, a problem with the cardinal splines is that they have an infinite duration. In fact, the cardinal spline of degree n is given by

$${η}^{n} ( x ) = {\sum }_{k ∈ Z} {( {b}_{1}^{n} )}^{- 1} ( k ) {β}^{n} ( x - k )$$

whose duration is infinite. One way to avoid this infinity problem is to apply truncation to the cardinal splines. Although truncation introduces some error, the error can be made arbitrarily small by making the truncation window large. Thus, if the number of pixels that need a high degree B-spline interpolation algorithm is small, the use of the cardinal spline may reduce the total processing time since the coefficients need not be computed. However, if the number of pixels that need a high degree B-spline interpolation algorithm is large, the conventional implementation will be more efficient.

What is claimed is:

1. A hybrid interpolation method comprising:
a simple interpolation algorithm;
a complex interpolation algorithm that requires a larger number of operations but provides a better performance than said simple interpolation algorithm;
prediction means that predicts an appropriate interpolation algorithm, which provides a high quality image with a minimum processing time, for a new pixel to be interpolated; and
performing means that chooses either said simple interpolation or said complex interpolation according to said prediction means and performs interpolation for said new pixel.

2. A hybrid interpolation method comprising:
a plurality of interpolation algorithms that vary in complexity and performance;
prediction means that predicts an appropriate interpolation algorithm, which provides a high quality image with a minimum processing time, for a new pixel to be interpolated; and
performing means that chooses one of said plurality of interpolation algorithms according to said prediction means and performs interpolation for said new pixel.

3. A hybrid interpolation method comprising:
a plurality of interpolation algorithms that vary in complexity and performance;
a plurality of prediction means that predict an appropriate interpolation algorithm, which provides a high quality image with a minimum processing time, for a new pixel to be interpolated; and
performing means that chooses one of said plurality of interpolation algorithms according to said plurality of prediction means and performs interpolation for said new pixel.
